(19) United States
(12) Patent Application Publication
(10) Pub. No.: US 2014/0312595 A1
(43) Pub. Date: Oct. 23, 2014

(54) DRAWBAR ASSEMBLY

(71) Applicant: BEAK Holdings Pty Ltd., Braeside Victoria (AU)

(72) Inventors: Terry Knowles, Braeside Victoria (AU); Paul Lavall, Braeside Victoria (AU)

(73) Assignee: BEAK Holdings Pty Ltd., Braeside Victoria (AU)

(21) Appl. No.: 13/966,327

(22) Filed: Aug. 14, 2013

(30) Foreign Application Priority Data
Apr. 18, 2013 (AU) 2013901368

(51) Int. Cl. B60D 1/54; B60D 1/145

(52) U.S. Cl. CPC B60D 1/54; B60D 1/145; B60D 2001/544
USPC 280/491.3

(57) ABSTRACT

The present invention relates to a drawbar assembly for interconnecting a vehicle such as trailer, to another vehicle, such a motor vehicle. The drawbar assembly includes a drawbar beam that pivots upward and downwardly and has a coupling portion at an outer end that interconnects to a co-operating coupling portion. The drawbar beam also has a force exerting mechanism, such as a torsion spring that is operable to support the drawbar beam unassisted (i.e., without manual assistance) in the lowered operative position to facilitate the coupling portion being hitched. The present invention also relates to a vehicle having the drawbar assembly fitted thereto.

### CROSS-REFERENCE TO RELATED APPLICATION

This application claims the benefit of Australian Application No. 2013901368, filed Apr. 18, 2013, which is incorporated by reference herein in its entirety.

### BACKGROUND OF THE INVENTION

1. Field of the Present Invention

The present invention relates to a drawbar assembly for connecting vehicles. For example, the drawbar assembly may be used for connecting a trailer to a motor vehicle. Trailers can be used for a wide range of purposes including transporting power generators such as ground power units (GPUs) used to power aircraft whilst on tarmac. In other examples, the drawbar assembly may be used for interconnected two or more trailers, such as, but by no means limited to cargo trailers for transporting baggage, mail and alike. Cargo trailers may be used at train stations, airports and so forth. The present invention also relates to a vehicle to which the drawbar assembly has been fitted.

2. Background of the Present Invention

Drawbar assemblies may be used for “on road” use and “off road” use in which frequent connection and disconnection between vehicles can be required. “Off road” drawbars may be used to connect vehicles at airports tarmacs, railway yards, mail distribution centres, warehouse terminals and alike. These types of applications typically require a high manoeuvrability between vehicles.

Drawbar assemblies for vehicles such as GPU trailers and cargo trailers may be required to pull loads of several tonne, with most GPUs weight approximately 2 tonne. The conventional drawbar assembly for these and other vehicles have a hitch ring at an outer end of a drawbar, and a steering or articulated connector that connects the drawbar to the chassis of the vehicle. The articulated connector is pivotally connected to the chassis by a vertical pivot pin, to allow side-to-side pivot movement of the connector. The outer end of the connector defines a yoke that is pivotally connected to the drawbar by a horizontal pin. The yoke is configured to allow the drawbar to pivot up and down about a horizontal pin under gravity.

One of the benefits of the conventional drawbar assembly is that drawbar can be pivoted into the stored upward orientation, thereby reducing the overall length of a line of vehicles parked close together. In order to couple the vehicle to another vehicle, a user lowers the drawbar from the upward orientation into a horizontal orientation, and manually holds the drawbar in an operative position while connecting the hitch ring to a co-operating hitch pin.

A disadvantage of the conventional drawbar is that the user, while holding the drawbar during connection, stands in a hazardous “crush” zone, between approaching vehicles. Another difficulty with the conventional drawbar assembly is that the drawbar itself is made of heavy duty steel and can weigh up to 40 kilograms. Manually raising and lower the drawbar during connection and disconnected, can, when performed repeatedly, cause physical duress and pain to the user.

Another shortcoming of the conventional drawbar assembly is that the hitch ring can wear and become a point of failure. In the absence of auxiliary safety mechanisms, such as safety chains, the load connected by the drawbar assembly to the vehicle can become unrestrained. Moreover, interconnecting safety chains from the drawbar assembly to the vehicle creates an additional step in the process of connecting the drawbar to the vehicle.

It is therefore an object of the present invention to provide an alternative drawbar assembly that can ameliorate, and suitably completely overcome the above disadvantages of the conventional drawbar assembly.

### SUMMARY OF THE PRESENT INVENTION

The present invention relates to a drawbar assembly for interconnecting a vehicle, such as trailer, to another vehicle, such a motor vehicle, wherein the drawbar assembly includes:

a drawbar beam having a coupling portion that interconnects to a co-operating coupling portion of the other vehicle;

a pivot mounting that is configured to allow the drawbar beam to be pivot between i) a lowered operative orientation in which the coupling portion presents for connection and ii) a stowed raised orientation in which the coupling is inoperative; and

a supporting mechanism that is operable to support the drawbar beam unassisted (i.e., without manual assistance from a person) in the lowered operative position to facilitate connection of the coupling portion to a co-operating coupling portion of another vehicle.

The supporting mechanism may be operable to at least partially assist in supporting the weight of the drawbar beam while moving between the operative and stowed orientations.

An advantage of the present invention is that drawbar beam can be supported in the operative position without a user manually holding the drawbar beam, thereby removing the user from the potential “crush” zone between approaching vehicles during connection.

The supporting mechanism may be a force exerting mechanism that allows the drawbar beam to pivot from the raised orientation to a lower operative orientation by gravity and support the drawbar beam in the operative orientation, or a position close to the operative orientation, to allow connection of the drawbar beam to the vehicle. It will be appreciated that in order to cater for vehicles of different height and undulating ground conditions, the force exerting mechanism may also be configured to allow the drawbar beam to pivot downward below or lower than the normal operating orientation.

The force exerting mechanism may control the speed or velocity at which the drawbar beam pivots from the raised orientation downward into the operative orientation. The force exerting mechanism may apply a force to the drawbar beam, at distance from the pivot point, in which the force varies depending on the degree to which the drawbar beam has pivoted toward the operative orientation. In other words, the force exerting mechanism applies a moment to the drawbar beam in response to the degree to which the drawbar beam has pivoted downward from the raised orientation.

Ideally, the force exerting mechanism is unpowered i.e., is not powered by an external or internal power source. Even more suitably, the force exerting mechanism includes a biasing element, for example a mechanical spring including a compression spring, an extension spring, a dampening device, a leaf spring and so forth. The biasing element may also include a strut such as gas strut or some other gas or fluid spring.

Suitably, the biasing element includes a torsion spring that is relatively unloaded when the drawbar beam is in the raised orientation, and is tensioned and exerts a force on the drawbar beam as the drawbar beam pivots into the operative orientation. The torsion spring suitably includes a length of tensile material including a coiled body and two limbs extending from the ends of the coiled body, in which one of the limbs has a fixed position relative to the drawbar beam and the other limb moves relative to the drawbar beam, and thereby becomes loaded during downward movement of the drawbar beam when moving from the stowed orientation to the operative orientation.

The force applied by the force exerting mechanism to the drawbar beam may increase as the drawbar beam moves from the raised orientation to the operative orientation and the force may decreases as the drawbar beam moves from the operative orientation to the raised orientation.

It is also possible that the force exerting mechanism may include an actuator such as, for example, an electrical ram, pneumatic ram or hydraulic ram. The actuator may be controlled by switches that are operable between settings that represent the lowered operative orientation and stowed raised orientation of the drawbar beam. The actuator may exert a force on the drawbar beam instead of, or in addition to, a force applied by the biasing element.

In any event, either one or both of the actuator and the biasing element may be configured to limit the range of pivotal movement of the drawbar beam. For example, either one or a combination of the biasing element or the actuator may be operable to prevent the drawbar beam from pivoting below a lowermost limited.

The biasing element spring may have a stiffness that prevents the drawbar beam from pivoting below a lowermost limited to avoid the drawbar beam from contacting the ground.

The lowermost limited may be when the drawbar beam is located at an angle up to 45 degrees below horizontal, or the operative orientation. Even more suitably the lowermost limit may be when the drawbar beam forms an angle up to 25 degrees or 15 degrees below horizontal, or the operative orientation.

The pivot mounting may include a first pivot axis about which the drawbar beam pivots between the operative and stowed orientations, and an axis through an opening defined by the coil body of the torsion spring is co-axial with the first pivot mounting.

The first pivot axis may be defined by a pin, and the pin passes through the opening of the coil body of the torsion spring to locate the torsion spring.

The assembly may also have a stopping formation that prevents pivotal movement of the drawbar beam below the lowermost limit. The pivot mounting may include the stopping formation.

The pivot mounting may also allow side-to-side pivotal movement of the coupling portion of the drawbar beam relative to the vehicle. It is possible that the upward and downward pivotal movement, and the side-to-side pivotal movement of the drawbar beam may be provided by a ball joint or other single device that allows multiple degrees of movement.

Suitably, the first pivot axis of the pivot mounting allows the drawbar beam to pivot upward and downward between the operative and stowed positions, and the pivot mounting includes a second pivot axis about which the drawbar beam can pivot side-to-side.

In one embodiment, the second pivot axis may be located along the length of the drawbar beam so that the drawbar beam has two sections that are articulated relative to each other.

Suitably the entire drawbar beam can pivot about the second pivot axis from side-to-side.

The second pivot axis may have an upright pivot axis, provided for example, by an upright pin about which the drawbar beam can pivot from side-to-side. For example, the second pivot axis may be in the form of a pin that passes through a part of the vehicle, such as the chassis of the vehicle and the drawbar assembly.

In another embodiment, the drawbar beam may pivot side-to-side by virtue of the drawbar beam being connected to a wheel axle of the associated vehicle, such as pivoting front axle. In this instance, the second pivot axis may or may not be provided.

The assembly may include a steering connector that connects the drawbar beam to the vehicle via the pivot mounting. Suitably, the steering connector is connected to the drawbar beam at the first pivot axis to allow upward and downward movement of the drawbar beam, and the steering connector to the vehicle at the second pivot axis to allow side-to-side movement of the drawbar beam. In this instance, the second pivot mounting also allows the steering connector to pivot from side-to-side.

In the situation in which the steering connector does not form part of the assembly, it is possible for the pivot mounting to pivotally connect the drawbar beam to the vehicle, for example, the chassis thereof, to provide upward and downward pivotal movement of the drawbar beam. However, it is preferred that the steering connector interconnect the drawbar beam to the vehicle.

At least one of i) the drawbar beam or ii) the steering connector may have a yoke formation comprising two spaced apart arms and a pin defining the first pivot axis extends between the arms and the drawbar beam pivots upward and downward about the pin. More suitably however, the yoke formation forms part of the steering connector, and the drawbar beam is disposed between the arms of the yoke formation. It is also possible that the drawbar beam and the steering connector may both have yoke formations that inter-fit and the pin defining the first pivot axis extends between the arms.

Suitably, the steering connector does not move upward and downward relative to the vehicle in the same manner as the drawbar beam. Moreover, when the force exerting mechanism is in the form of the spring having two limbs, ideally one of the limbs is fixed relative to the steering connector and the other is fixed to the drawbar beam, so that loading of the spring increases as the drawbar beam pivots downward relative to the steering connector (and the vehicle).

The assembly may have a point of weakness located at a point remote from the coupling portion of the drawbar beam so that the assembly has a structurally detachable portion and a non-detachable portion that remains attached to the vehicle when the point of weakness has failed. The point of weakness is configured to fail in the event of an excessive load is applied to the assembly and the detachable portion includes the coupling portion and part of the drawbar beam. An excessive load may be the result of fatigue caused by loads applied over a period of time, or a single load that exceeds operating parameters. It is possible that the point of weakness may be provided at a point along the length of the drawbar beam. Suitably, however, the point of weakness may be provided at the pivot mounting, and suitably either one or a combination of the first and second pivot axes. Ideally however, the point of weakness is located at the first pivot axis and in the event of failure, the drawbar beam becomes detached from the remainder of the mounting assembly, for example the steering connector.

The assembly may also include an auxiliary retaining member, such as a safety chain or other tie member, wherein the auxiliary retaining member either: i) interconnects the detachable portion to the non-detachable portion, or ii) interconnects the detachable portion to the vehicle. One of the benefits of this aspect is that the auxiliary retaining member is not required to be connected and disconnected on every occasion the drawbar assembly is used to couple the vehicle to another vehicle. Moreover, in the case of conventional drawbar assemblies in which the hitch ring is the point of weakness and a safety chain is not used, the vehicles will become completely disconnected, which can result in the vehicle, for example, a trailer becoming unrestrained. The combination of a point of weakness remote from the coupling portion and the auxiliary retaining member, avoids the need to engage the auxiliary retaining member on each occasion the drawbar is engaged.

The coupling portion of the drawbar beam may be any suitably coupling such as a hitch ring, hitch pin that is received by a hitch ring, or a ball and socket arrangement.

The drawbar beam and/or the steering connector may have any suitable form including a C-shaped member, a H-shaped member, or an assembly of members connected together in the form of a truss. In one example the drawbar beam and/or the steering connector includes a length of tubular section.

The present invention also relates to a drawbar assembly for interconnecting a vehicle having the drawbar assembly to another vehicle, the assembly includes:

a drawbar beam having a coupling portion at an outer end that interconnects to a co-operating coupling portion;

a pivot mounting that is configured to allow the drawbar beam to be pivot between i) a lowered operative orientation in which the coupling portion presents for connection and ii) a stowed upward orientation in which the coupling is inoperative;

the assembly having a point of weakness located at a point other than at the coupling of the drawbar beam so as to define a structurally detachable portion from the assembly and a non-detachable portion that remains attached to the assembly; and

wherein at least one auxiliary retaining member, such as a safety chain or other tie member, interconnects the detachable portion to either one or a combination of i) the non-detachable portion or ii) to the vehicle.

The drawbar assembly described in the paragraph immediately above may include any one or a combination of other features described herein.

The present invention also relates to a vehicle having the drawbar assembly, as described in any one of the preceding paragraphs, wherein the drawbar assembly is attached to the chassis of the vehicle. In the situation in which the drawbar assembly includes a steering connector, the steering connector may be pivotally connected to the chassis of the vehicle about an upright pin or rod.

### BRIEF DESCRIPTION OF THE DRAWINGS

A preferred embodiment of the present invention will now be described with reference to the accompanying drawings, of which:

FIG. 1 is a schematic side view of the drawbar assembly illustrating the drawbar beam in both i) a lowered operative orientation for connection and ii) a raised stowed orientation, and in which the drawbar assembly is attached to a chassis of an associated vehicle;

FIG. 2 is a perspective view of the drawbar assembly illustrated in FIG. 1 attached to the chassis of an associated vehicle with the drawbar beam located in the raised stowed position;

FIG. 3 is a schematic exploded view of a the drawbar assembly including a drawbar beam, a steering connector, a force exerting mechanism in the form of a torsion spring and two pivot mountings including a horizontal pivot mounting and an upright pivot mounting, the pivot axis of both being defined by pins, and a safety retaining chain interconnecting the drawbar beam and the steering connector;

FIG. 4 is a schematic detailed view of the drawbar beam connected to the steering connector whilst the drawbar beam is located in the raised stowed orientation as shown in FIG. 2; and

FIG. 5 is a schematic perspective view of the torsion spring that exerts a force on the drawbar beam as it pivots between the lowered operative position and the raised stowed position.

### DETAILED DESCRIPTION

A preferred embodiment of a drawbar assembly will now be described with reference to the accompanying drawings. The following text includes a set of reference numerals that identify particular feature in the drawings. In order to main clarity of the drawings, however, each reference numeral has not been included in every drawing.

The drawbar assembly 10 is mounted to, and extends from, a chassis 11 of an associated vehicle, such as a trailer. The drawbar assembly 10 may be used for connecting the trailer to a motor driven vehicle. It will be appreciated that the drawbar assembly 10 may be used for interconnecting a range of other vehicles including interconnecting one trailer to another trailer to form a line.

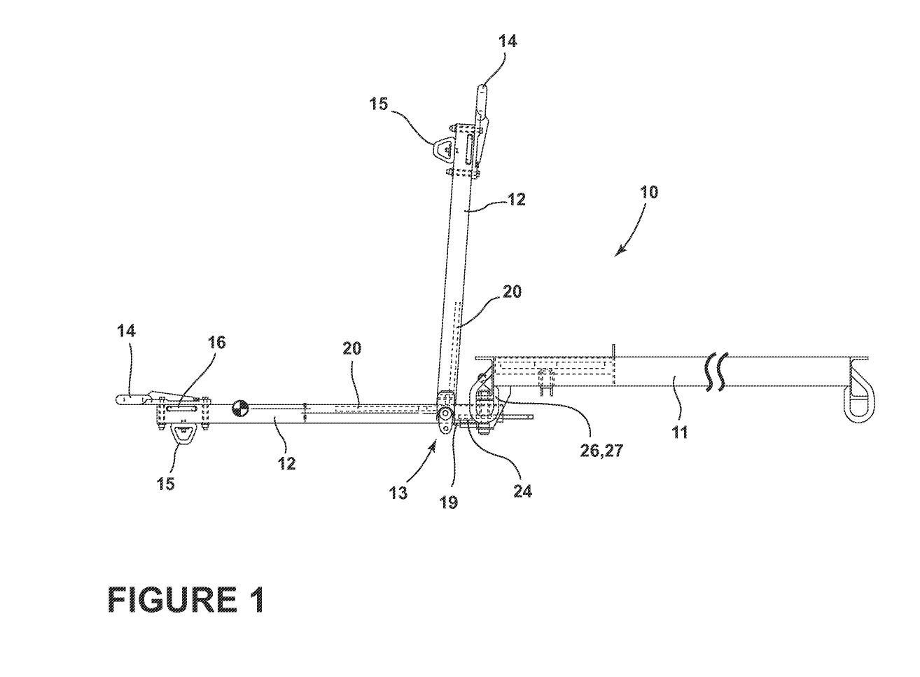

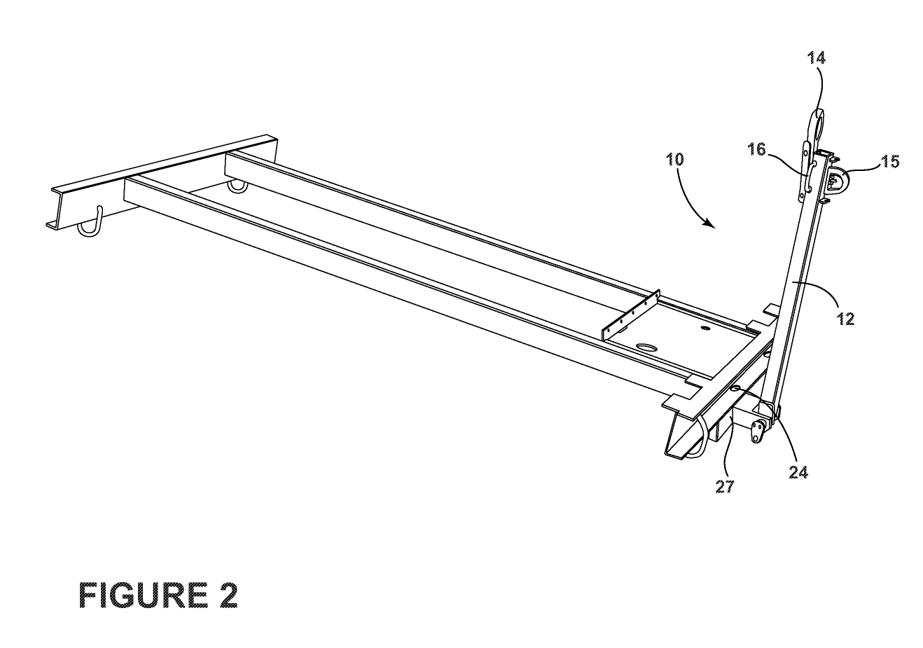

With reference to the Figures, the drawbar assembly 10 includes a pivot mounting 13 having a first pivot axis about which the drawbar beam 12 pivots between a lowered operative orientation and a raised stowed orientation. The raised and operative positions are clearly shown in FIG. 1. The assembly 10 also includes a force exerting mechanism that is operable to support the drawbar beam 12 in the lowered operative orientation, and assists in supporting the weight of the drawbar beam 12 whilst in the process of being lowered from the raised orientation to the operative orientation.

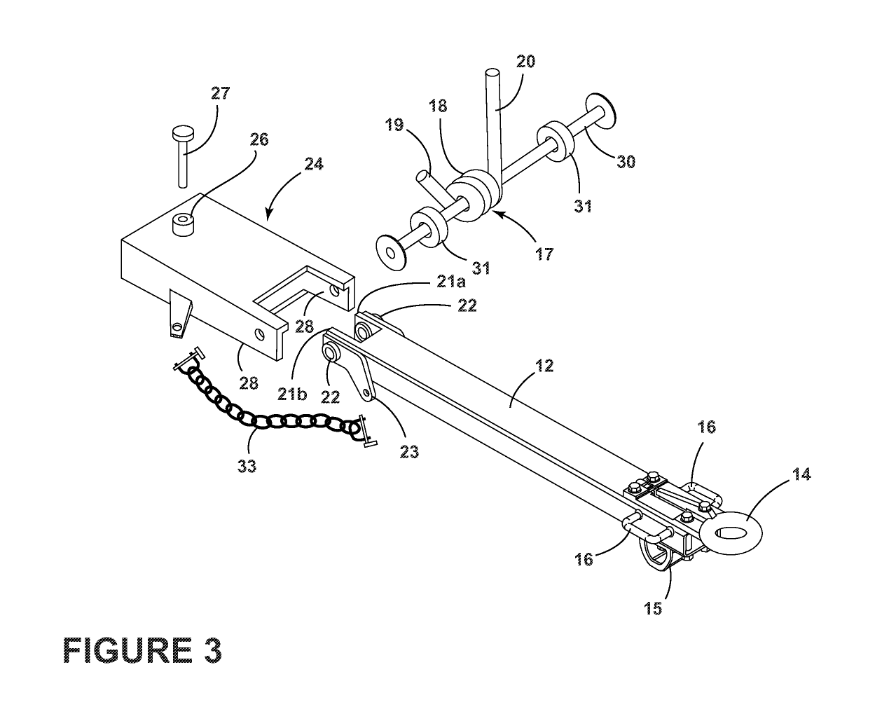

The assembly and particularly, the drawbar beam 12 may be made of any suitable material but is suitably made from high tensile carbon steel. The drawbar beam 12 may have any geometry and is suitably tubular, such as quadrangular tubular section. A coupling portion is fitted to an outer end of the drawbar beam 12 which is in the form of a hitch ring 14 defining an opening that receives a hitch rod on the back end of a vehicle to which it is attached (not shown in the Figures). The hitch ring 14 is fitted on the upper face of an outer end of the drawbar beam 12 via four bolts passing through the drawbar beam 12, and a flexibly deformable fender 15 is fitted on the lower face of the drawbar beam 12 for engaging the ground. Two C-shaped handles 16 extend laterally from opposite sides of the drawbar beam 12 so that a user can manually raise and lower the beam 12. One of the benefits of the preferred embodiment is that the forcing exerting mechanism, namely a torsion or tension spring 17, best seen in FIGS. 3 to 5, will become loaded as the drawbar beam 12 pivots downward. The spring 17 is tensioned as the drawbar beam 12 is pivot into the lowered operative position, which is the lowermost position shown in FIG. 1.

As can best be seen in FIG. 5, the spring 17 includes a length of the tension steel having a central coiled body 18 and two arms, namely a short arm 19 and a long arm 20 extending from opposite ends of the coiled body 18 at an angle of approximately 90 degrees when in a relaxed state. The short arm 19 is held in a first orientation in which it is enclosed in, or received by, an opening of the drawbar assembly or some other part of the associated vehicle, and the longer arm 20 extends along the drawbar beam 12. Pivotal movement of the drawbar beam 12 creates tension in the coiled body 18 as the long arm 20 moves away from the short arm 19 over an arch of at least 80 degrees, and suitably at least 90 degrees and even more suitably in the range of the 90 to 110 degrees. The angle between the arms 19, 20 is increased to approximately 180 degrees when the drawbar beam 12 is in the operative orientation.

When the drawbar beam 12 is in the raised position, the spring 17 will not exert a force on the drawbar beam 12 as the spring 17 will be in a relaxed neutral position. However, it will be appreciated that this need not be the case, and that the spring 17 can be pre-loaded so as to exert a force on the drawbar beam when in the raised orientation. In any event, as the drawbar beam 12 is lowered, moments applied by the spring 17 to the drawbar beam 12 when in the lowered operative position balances the gravitation pull on the drawbar 12. As the spring 17 becomes further loaded by being lowered from the raised stowed position, the spring 17 assists the user so that the user is not required to support the full weight of the drawbar beam 12. Ideally however, when in the lowered operative orientation, the drawbar beam 17 is fully supported by the spring 17 without a user manually supporting the drawbar beam.

It will be appreciated that the work performed by the spring 17, namely the work of the short arm 19 and the work of the long arm 20 will balance when the spring is loaded. In this position, the drawbar beam 12 will be held substantially static.

The torsion properties of the spring 17, ideally prevent the drawbar beam from pivoting below a lowermost limit (not illustrated in the drawings). The lowermost limit may be up to 45 degrees below the horizontal.

It is within the scope of the present invention that the force exerting mechanism may also include an actuator (not shown in the drawings) that is operable to lower the drawbar beam 12 from the raised position downward. The actuator may operate with or without the aid of an external power source. In this case, a user may not be required to support, or at least partially support, the weight of the drawbar beam 12 while the beam 12 is being lowered in to the operative orientation. The actuator may be driven by any suitable means including devices driven hydraulically, pneumatically, and electrically or by any other power source. When an actuator is provided, the force exerting mechanism may or may not include the spring 17. Alternatively, when the force includes both a biasing element such as a spring 17, and an actuator, the actuator may be turned off when the drawbar beam 12 is in an operative position.

One of the benefits provided by the preferred embodiment is that the spring 17 is able to support the drawbar beam 12 unassisted in the operative position. In other words, the preferred embodiment removes the need for a user to stand in the potential “crush” zone between approaching vehicles.

As can best be seen in FIGS. 3, the inner end of the drawbar beam 12 includes a first yoke formation comprising a pair of spaced apart arms 21a, 21b. Each arm 21a, 21b has a pair of horizontally arranged pivot bosses 22 for receiving a horizontal pivot pin 30 defining a first pivot mounting 13. A restraining plate 23 is welded to an outside face of each of the fingers to which a safety chain is attached.

Although not shown in the Figures, a pivot mounting 13 may connect the drawbar beam 12 directly to the associated vehicle, for example, to the chassis of the associated vehicle. In the case of the preferred embodiment however, the drawbar assembly 10 also includes a steering connector 24 that interconnects the drawbar beam 12 to the associated vehicle. Suitably, the steering connector 24, and the drawbar beam connected there to, pivot from side-to-side about a second pivot in turn is pivotally mounting 13 includes a second pivot axis 25 that pivotally mounts the steering connector 24 about an upright pivot pin 26, so as to allow the steering connector 24 to pivot from side-to-side, and thereby increase articulation. Ideally, the second pivot axis 25 does not allow the steering connector 24 to pivot upward and downward, although this may be possible.

The steering connector 24 is a rectangular tubular sleeve and the second pivot axis 25 is in the form of a vertically arranged boss 26 through an inner end of the steering connector that receives a second pivot pin 27. Although not shown in the drawings, the second pivot pin 27 is also received by co-operating openings or bosses attached to the main chassis of the associated vehicle.

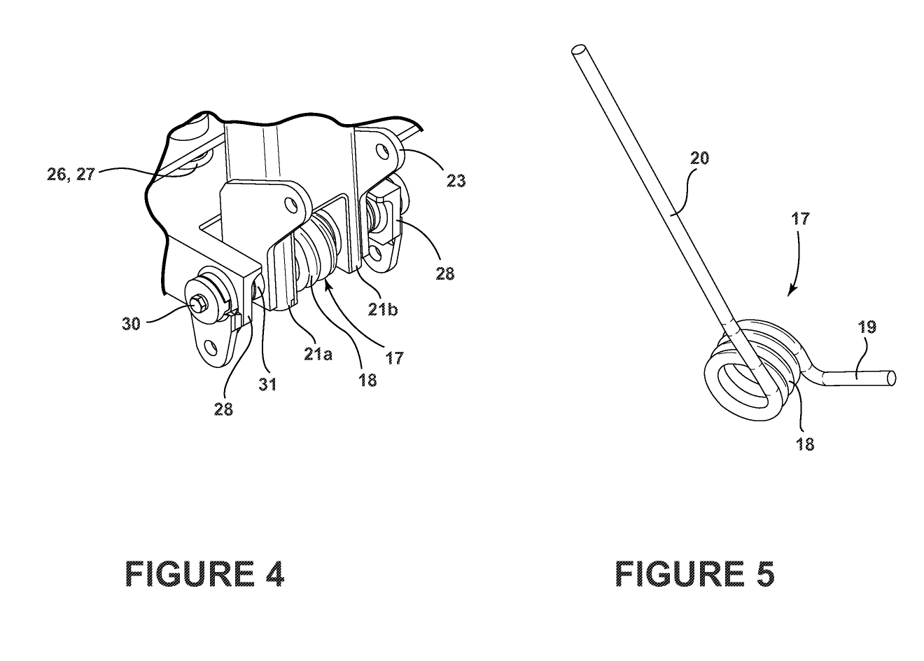

The outer end of the steering connector 24 includes a second yoke formation 32 comprising a second pair of spaced apart cheek plates 28. FIG. 4 illustrates the drawbar beam 12 and the steering connector 24 assembled together which includes: i) the short arm 19 of the spring being located or confined to the tubular sleeve of the steering beam and ii) the long arm 20 of the spring 17 being located or confined to the tubular sleeve of the drawbar beam 12. FIG. 5 illustrates the spring 17 in a neutral position in which the short arm is oriented approximately 90 degrees to the long arm 20.

When assembled, the first pivot bosses 22 are aligned with the openings in the cheek plates 28 of the steering connector 24 and the arms of the spring 17 located in position with the short arm 19 enclosed in the tubular body of the steering connector 24 and the long arm 20 enclosed in the tubular body of the drawbar beam 12. The centre of the coiled body 18 is threaded over the first pivot pin 30. In addition, spacers 31 are located either side of the drawbar beam, and inside the cheek plates 28, so as to centrally locate the drawbar beam 12 between the second yoke formation 32 of the steering connector 24. The cheek plates 28 are configured to provide a point of weakness in the drawbar assembly. Specifically, the cheek plates 28 are designed to fail by shearing in the event of an excessive load been applied to the drawbar assembly 10 and thereby protect the other components from failing.

In other words, the drawbar beam 12 is a detachable component of the drawbar assembly 10, and a safety chain 33 can be used to connect the detachable component, in this instance the drawbar beam 12, to the non-detached part, in this instance, the steering connector 24. In the case where the steering connector 24 is not provided, the safety chain 33 can be used to connect the detachable component to the chassis or another part of the associated vehicle. An advantage provided by this arrangement is that the safety chain 33 will remain operatively connected to the detachable and non-detachable components, irrespective of whether the drawbar assembly 10 couples the respective associated vehicle to another vehicle. In other words, the safety chain is not required to the connected on each occasion that the drawbar assembly is engaged.

In the case of conventional drawbar assemblies, the point of weakness is typically the hitch ring. A safety chain is therefore required to connect the drawbar assembly to the vehicle, which would need to be connected and disconnected on each occasion the coupling is engaged. As a result, the need to connect safety chains when the vehicles are frequently hitch and unhitch can become tiresome, and in some instances omitted from practice as a result.

An advantage of the present invention is the drawbar assembly can be retrospectively fitted to existing vehicles.

Those skilled in the art of the invention will appreciate that many variations and modifications of the invention may be made the preferred embodiment described above without departing from the spirit and scope of the present invention.

For example, although not shown in the drawings, a latch, may be mounted to the side of the associated vehicle to secure hold the drawbar beam 12 in an upright in the stowed orientation.

1. A drawbar assembly for interconnecting a vehicle, such as trailer, to another vehicle, such a motor vehicle, wherein the drawbar assembly includes:
a drawbar beam having a coupling portion that can interconnect to a co-operating coupling portion;
a pivot mounting that is configured to allow the drawbar beam to be pivot between i) a lowered operative orientation in which the coupling portion presents for connection and ii) a stowed raised orientation in which the coupling is inoperative; and
a supporting mechanism that is operable to support the drawbar beam unassisted (i.e., without manual assistance) in the lowered operative position to facilitate connection of the coupling portion to a co-operating coupling portion of another vehicle.

2. The drawbar assembly according to claim 1, wherein the supporting mechanism is a force exerting mechanism and is operable to at least partially assist in supporting the weight of the drawbar beam while moving between the operative and stowed orientations.

3. The drawbar assembly according to claim 1, wherein the supporting mechanism is a force exerting mechanism that is unpowered i.e., is not powered by an external or internal power source, and the force applied is in response to the weight of the drawbar beam acting on the force exerting mechanism.

4. The drawbar assembly according to claim 3, wherein the force exerting mechanism exerts a force on the drawbar beam, at distance from the pivot mounting to balance moments of the drawbar beam about the pivot mounting as a result of the weight of the beam, and the force of the forcing exerting mechanism on the beam increases as the drawbar beam pivots from the raised orientation to a lowered operative orientation.

5. The drawbar assembly according to claim 4, wherein the force exerting mechanism includes a biasing element.

6. The drawbar assembly according to claim 5, wherein the biasing element includes a torsion spring that is relatively unloaded when the drawbar beam is in the raised orientation, and becomes tensioned so as to exert a force on the drawbar beam as the drawbar beam pivots into the operative orientation, and wherein the torsion spring has a coiled body and two limbs extending from the coiled body, in which one of the limbs has a fixed position relative to the drawbar beam and the other limb moves relative to the drawbar beam, and thereby becomes loaded during downward movement of the drawbar beam when moving from the stowed orientation to the operative orientation.

7. The drawbar assembly according to claim 6, wherein the pivot mounting includes a first pivot axis about which the drawbar beam pivots between the operative and stowed orientations, and an axis through an opening defined by the coil body of the torsion spring is co-axial with the first pivot mounting.

8. The drawbar assembly according to claim 7, wherein the first pivot axis is defined by a pin, and the pin passes through the opening of the coil body of the torsion spring to locate the torsion spring.

9. The drawbar assembly according to claim 5, wherein the torsion spring has a stiffness that prevents the drawbar beam from pivoting below a lowermost limited to avoid the drawbar beam from contacting the ground.

10. The drawbar assembly according to claim 1, wherein the pivot mounting has a second pivot axis that allows side-to-side pivotal movement of the drawbar beam relative to the vehicle.

11. The drawbar assembly according to claim 10, wherein the entire drawbar beam can pivot about the second pivot axis from side-to-side.

12. The drawbar assembly according to claim 1, wherein the assembly includes a steering connector that connects the drawbar beam to the vehicle via the pivot mounting.

13. The drawbar assembly according to claim 12, wherein the steering connector is connected to the drawbar beam at a first pivot axis to allow upward and downward pivotal movement of the drawbar beam, and the steering connector is connected to the vehicle at the second pivot axis to allow side-to-side pivotal movement of the drawbar beam.

14. The drawbar assembly according to claim 13, wherein at least one of i) the drawbar beam or ii) the steering connector may have a yoke formation comprising two spaced apart arms and a pin defining the first pivot axis extends between the arms and the drawbar beam pivots about the pin.

15. The drawbar assembly according to claim 6, wherein the assembly includes a steering connector that connects the drawbar beam to the vehicle, and wherein the force exerting mechanism is in the form of the torsion spring having two limbs, one of the limbs is located relative to the steering connector and the other is located relative to the drawbar beam, so that loading of the spring increases as the drawbar beam pivots downward relative to the steering connector.

16. The drawbar assembly according to claim 1, wherein the drawbar beam is connected to a pivoting axle of the vehicle, which allows the drawbar beam to pivot side-to-side by virtue of the drawbar beam relative to a body of the vehicle.

17. The drawbar assembly according to claim 1, wherein the assembly has a point of weakness located at a point remote from the coupling portion of the drawbar beam so that the assembly has a structurally detachable portion including the coupling portion, and a non-detachable portion that remains attached to the vehicle when the point of weakness has failed.

18. The drawbar assembly according to claim 17, wherein the point of weakness is provided by the pivot mounting that allows upward and downward pivotal movement of the drawbar beam, and wherein the pivot mounting includes plates through which a pin defining the pivot axis of the pivot mounting extends and, the plates together have a lower loading threshold than the coupling portion.

19. The drawbar assembly according to claim 17, wherein the assembly includes an auxiliary retaining member that either: i) interconnects the detachable portion to the non-detachable portion, or ii) interconnects the detachable portion to the vehicle.

20. A drawbar assembly for interconnecting a vehicle having the drawbar assembly to another vehicle, the assembly includes:
a drawbar beam having a coupling portion at an outer end that interconnects to a co-operating coupling portion;
a pivot mounting that is configured to allow the drawbar beam to be pivot between i) a lowered operative orientation in which the coupling portion presents for connection and ii) a stowed upward orientation in which the coupling is inoperative;
the assembly having a point of weakness located at a point other than at the coupling of the drawbar beam so as to define a structurally detachable portion from the assembly and a non-detachable portion that remains attached to the assembly; and
wherein at least one auxiliary retaining member, such as a safety chain or other tie member, interconnects the detachable portion to either one or a combination of i) the non-detachable portion or ii) to the vehicle.

21. A vehicle having the drawbar assembly according to claim 1, wherein the drawbar assembly is attached to the chassis of the vehicle.

22. The vehicle according to claim 21, wherein the drawbar assembly includes a steering connector interconnecting the drawbar beam to the vehicle, and the pivot mounting includes a first pivot axis that interconnects the drawbar beam to the steering connector so that the drawbar beam pivots upward and downward relative to the steering connector, and the steering connector is pivotally connect to the vehicle about an upright pivot axis to allow side-to-side movement of the drawbar beam.

23. A vehicle having the drawbar assembly according to claim 20, wherein the drawbar assembly is attached to the chassis of the vehicle.

24. The vehicle according to claim 23, wherein the drawbar assembly includes a steering connector interconnecting the drawbar beam to the vehicle, and the pivot mounting includes a first pivot axis that interconnects the drawbar beam to the steering connector so that the drawbar beam pivots upward and downward relative to the steering connector, and the steering connector is pivotally connect to the vehicle about an upright pivot axis to allow side-to-side movement of the drawbar beam.
